(19) United States
(12) Patent Application Publication
(10) Pub. No.: US 2003/0055705 A1
(43) Pub. Date: Mar. 20, 2003

(54) Method and apparatus for skills-based task routing

(75) Inventor: Joel Frederick Kilpatrick, Durham, NC (US)

Correspondence Address: CENTRAL COAST PATENT AGENCY, PO BOX 187, AROMAS, CA, 95004, US

(73) Assignee: International Business Machines Corporation, Armonk, NY (US)

(21) Appl. No.: 09/884,776

(22) Filed: Jun. 19, 2001

(51) Int. Cl. G06F 17/60

(52) U.S. Cl. 705/9

(57) ABSTRACT

The invention selects agents in a service center to service individual tasks based on agent skills required to service the tasks. All agent skills relevant to processing a task are ascertained out of a set of N defined skills. A skill expression is established that defines a logical relationship between the relevant skills sufficient to qualify an agent to service the task. A weight is calculated for each relevant skill that represents the relative importance of the skill in the skill expression. A set of agents qualified to service the task is derived according to the skill expression. A score is calculated for each qualified agent using the calculated weights, wherein each score represents the closeness of the associated agent's qualifications to the skill expression. Finally, an agent is selected to service the task according to the calculated scores.

### TECHNICAL FIELD

The invention relates to the field of service center operation. Specifically, it relates to efficiently selecting agents for servicing incoming tasks or outgoing tasks based on sets of skills required to service the individual tasks. The invention further relates to selecting agents having adequate, but minimal, skills to service these tasks.

### BACKGROUND OF THE INVENTION

There are many known algorithms which have been used to route tasks, such as incoming calls, electronic mail, facsimile and World-Wide-Web requests and the like, to agents within a group or groups in call and service centers. Recently, operators have realized the importance of task routing based on the skills of agents as compared to the needs required to adequately service individual tasks. For instance, a telephone caller may require expertise in a particular software or hardware system, or expertise in a particular sector of the financial market, or a specific company. The same is true of a person requesting assistance by e-mail or other means. Further, a caller may speak only a specific language and therefore require an agent fluent in that language. The list of possible skills goes on, and are defined by the owners of the individual service centers according to the purposes of the service centers.

U.S. Pat. No. 5,825,869, issued to Brooks et. al. On Oct. 20, 1998, describes a system for skill-based routing of telephone calls. Brooks attempts to select agents whose proficiency in specified skills are closest to the required proficiency levels of one or more required skills. Brooks also discloses the notion of weighting skills, referred to as skill preferences, according to call center management decisions that place different values on different skills. For example, management might decide that a skill A is worth twice that of skill B, and this value judgment is used in some way in selecting agents.

Two other skills-based routing algorithms are disclosed in two recent patent application Ser. Nos. 09/455,088 and 09/455,284 filed by IBM in the name of Joe Agusta. Agusta uses a more sophisticated selection algorithm than Brooks. Agusta, however, requires the use of elaborate data structures that are manipulated in a way to find the best agent to service a task. While the Agusta data structures and algorithm function to achieve the desired goal of selecting agents, the approach requires considerable processing overhead. Brooks, on the other hand, while introducing the notion of weighting preferences according to management subjective criteria, discloses no specific algorithm for applying such weights, nor does Brooks disclose the notion of calculating weights to be applied to each preference according the importance of a skill in satisfying a specific logic expression of skills that satisfy a particular task.

### SUMMARY OF THE INVENTION

The invention selects agents in a service center to service individual tasks based on agent skills required to service the tasks. In response to a task to be serviced, all agent skills relevant to processing the task are ascertained out of a set of N defined skills. In the preferred embodiment, a level of proficiency for each relevant skill is also determined. However, in general all proficiency levels can be considered as equal to one (1) if desired. A skill expression is established that defines a logical relationship between the relevant skills and their respective proficiency levels sufficient to qualify an agent to service the task. A weight is calculated for each relevant skill that represents the relative importance of the skill in the skill expression. A set of agents qualified to service the task is derived according to the skill expression. A score is calculated for each qualified agent using the calculated weights, wherein each score represents the closeness of the associated agent's qualifications to the skill expression. Finally, an agent is selected to service the task according to the calculated scores.

In the preferred embodiment, a weight wᵢ for a given skill i is calculated with the equation

$$\frac{a}{{2}^{m - 1}} ,$$

where a equals the number of times in the truth table corresponding to the skill expression that both the skill i and the skill expression are logically true and m is the number of unique skills specified in the skill expression. A total weight variable TW is calculated that is equal to the summation of the individual calculated weights of the relevant skills. A smallest weight variable SW is calculated that is equal to the smallest summation value of the skill weights such that the particular combination of skills satisfies the skill expression. A variable NZ is calculated to be the number of Wᵢ variables where the weight is not zero. A matched weight variable MW is calculated for each agent that is equal to the summation of the calculated weights for each skill possessed by the agent.

A distance variable D is calculated for each agent equal to

$$D = ( 1 - {\sum }_{i = 1 … q} \frac{{w}_{i} \times ( {SP}_{i} - {EP}_{i} )}{10 \times q} ) .$$

where SPᵢ is the proficiency of the agent for skill i and EPᵢ is the required proficiency of skill i and q is the number of common skills between the agent and the task's skill expression.

A logic ratio variable LR is also calculated that is equal to

$$LR = 1 - ( \frac{\frac{( TW - SW )}{NZ}}{2} ) .$$

The logical ratio LR is used to rank skill expressions with all of the skills AND'ed together as the highest value (LR=1) down to skill expressions with only OR'ed skills

$$LR = 1 - ( \frac{\frac{NZ - 1}{NZ}}{2} )$$

which is close to ½.

A weight ratio variable WR is calculated for each agent equal to

$$WR = 1 - ( \frac{MW - SW}{TW} ) .$$

The weight ratio is used to rank agents that qualify with a subset of the skills specified in the skill expression above agents that have all the relevant skills.

A non-relevant skills ratio NR is calculated for each agent equal to

$$NR = min ( 1 , \frac{{2}^{m}}{{2}^{n}} ) .$$

The non-relevant skills ratio is used to scale down the overall score for agents that have extra skills not required to satisfy the skill expression. The minimization function is used to ensure the ratio does not exceed 1 when an agent with only a subset of the skills specified in the skills expression is eligible to handle the task.

Finally, a score S is calculated for each agent equal to

S=D×LR×WR×NR

and an agent is selected to service the task based on the value of S.

The formulas specified above require that the skill expression associated with a task has an inclusive set of skills that satisfies it. Exclusionary expressions such as “NOT A AND NOT B” have no meaning since their total weight is zero. Such expressions could be converted to inclusive expressions or another criteria such that the agent that has been available the longest is used.

### BRIEF DESCRIPTION OF THE DRAWING

In the drawing,

FIG. 1 is an illustrative flowchart of steps that show how a set of agents operate with an Interaction task queue while using the scoring according to the inventive steps of weighting skills and applying the formulas described herein.

### DETAILED DESCRIPTION

The skills-based routing algorithm can be described mathematically as follows.

A skill set (S₁, S₂ . . . Sn) can be described as a set of n skills that are relevant to a system or an agent group within a system. A skill can be any desired capability or expertise. Examples might be, for example, expertise in a particular software application program, fluency in a particular language, membership in a sales group or in some other identified capability.

Individual agents have a set of skills that are a subset of the skill set and a proficiency SP in each skill. In the preferred embodiment, proficiencies range from zero to ten (0-10). A value of 10 represents the highest level of skill recognizable by a system. A value of zero means that the particular agent does not have the particular skill in question.

An incoming task to be serviced has associated with it a required set of m skills (S₁, S₂ . . . Sₘ) and corresponding proficiencies (EP₁, EP₂ . . . EPₘ) and a skill expression that describes the logical relationship of those skills and proficiencies that an agent must possess to qualify for the task.

In accordance with the invention, each required skill is also associated with a computed weight W(m). The weight for each skill is computed from the truth table representing the skill expression without regard to proficiency levels by counting the number of entries in which both the skill and the skill expression are True and dividing that result by the value 2ⁿ⁻¹. For example, if a task requires three skills SALES, SUPPORT AND SHIPPING, and the skill expression is SALES=a and SUPPORT=b and SHIPPING=c, where a, b and c are proficiency levels, the truth table for the skill expression, ignoring the proficiency levels, is

| | | | SALES and |
|---|---|---|---|
| SALES | SUPPORT | SHIPPING | SUPPORT and SHIPPING |
| True | True | True | True |
| True | True | False | False |
| True | False | True | False |
| True | False | False | False |
| False | True | True | False |
| False | True | False | False |
| False | False | True | False |
| False | False | False | False |
| Y(1) = 1 | Y(2) = 1 | Y(3) = 1 | |

The weights W(1) for each of the skills are Y(I)/2^{m-1}=Y(I)/4, or ¼, ¼ and ¼ for SALES, SUPPORT AND SHIPPING, respectively, for this particular skill expression. Y(1), Y(2)_{, and} Y(3) are equal to the number of times that the variable Y in question is true at the same time as the overall skill expression is also true. In this case, this is the value 1 (one) for all three variables (taken from the first row of the truth table)

If the skill expression were instead SALES=a and SUPPORT=b or SHIPPING=c, the truth table is

| | | | SALES and |
|---|---|---|---|
| | | | SUPPORT or |
| SALES | SUPPORT | SHIPPING | SHIPPING |
| True | True | True | True |
| True | True | False | True |
| True | False | True | True |
| True | False | False | False |
| False | True | True | True |
| False | True | False | False |
| False | False | True | True |
| False | False | False | False |
| Y(1) = 3 | Y(2) = 3 | Y(3) = 4 | |

In this example, the weights are Y(I)/2^{m-1}=Y(I)/4, or ¾, ¾ and 4/4, respectively, for SALES, SUPPORT AND SHIPPING.

Continuing on with the mathematical definition of the algorithm: TotalWeight is defined as the sum of all individual weights of the skill set divided by the number m of skills in the set, or

$$1 ) TotalWeight ( TW ) = {\sum }_{i = 1 … m} {w}_{i}$$

$$2 ) MatchedWeight ( MW ) = {\sum }_{i = 1 … q} {w}_{i} ,$$

where q is the number of skills in common in both the skill set and the skill expression (I represents the skills S(I) that are members of the skill set and the skill expression) and SPᵢ>=EPᵢ. SPᵢ is a proficiency value possessed by an agent for a skill l; EP is a proficiency value required as part of a skill expression. Both of these values lie within discrete ranges. In the disclosed embodiment, these values will be from 0 to 10. Zero (0) means that a skill is not required, or that an agent does not possess the skill, depending on the context.

$$3 ) Distance ( D ) = ( 1 - {\sum }_{i = 1 … q} \frac{{w}_{i} \times ( {SP}_{i} - {EP}_{i} )}{10 \times q} ) ,$$

where i describes a skill S(i) that is a member of the skill set and skill expression and SPᵢ>=EPᵢ.

$$4 ) LogicRatio ( LR ) = 1 - ( \frac{\frac{( TW - SW )}{NZ}}{2} ) \\ 5 ) WeightRatio ( WR ) = 1 - ( \frac{MW - SW}{TW} )$$

$$6 ) Non \text{-} Relevant Skills ( NR ) = min ( 1 , \frac{{2}^{m}}{{2}^{n}} )$$

7) Score (S)=D×LR×WR×NR

In equations 1 through 7,

a) m is the number of unique skills appearing in the logical expression.

b) n is the number of unique skills appearing in the skill set.

c) q is the number of skills in both the skill set and the skill expression.

d) Wᵢ is a fraction ranging from

$$\frac{1}{{2}^{m - 1}}$$

to 1.

e) TotalWeight is the weight total of all skills in the expression.

f) MatchedWeight is the weight of all matching skills in the skill set for a given agent.

g) Distance is the vector proficiency difference of the common skills between the skill expression and skill set away from the value 1.

h) LogicRatio is a value used to differentiate between a skill expression where all the skills are AND'ed together and one where all the skills are OR'ed together, respectively.

i) WeightRatio is a value used to differentiate between the minimally required skilled agent with relevant skills a more skilled agent that both qualify to handle the task.

j) Non-relevant Skills Ratio is used to scale down scores for agents with extra skills not required to satisfy the skill expression.

k) Score (S) is the distance and logic ratio score multiplied by the weight ratio and non-relevant skills in the skill set to the skills contain in the logical expression.

In selecting an agent to service a given task, the score S is calculated for each potential agent that is available and qualified. Qualified means possessing all required skills and proficiency levels. A perfect score (S) of 1 means an exact match between the required skills and proficiencies and those possessed by the agent. An agent with a score of 1 is selected, if possible. Agents with scores less than 1 are overqualified. If no exact matching agent is available, then one with the largest score that is less than 1 is selected to service a task. To further illustrate the algorithm, assume an example with five skills A, B, C, D, and E in both the skill set and the skill expression. Proficiency values of 1 are assumed for these examples for all skills to better illustrate how the calculated weighting function works. Furthermore, NR=1 since the skill set and the expression both contain the same skills. Scores will be calculated for the following tasks:

Assume the following four interactions:

Task(1)=(A & B & C & D & E)

Task(2)=(A|B|C|D|E)

Task(3)=(A&B) (C&D&E)

Task(4)=(A &!B)|(C &!D)|(A & E),

where &=logical AND, |=logical OR, !=logical NOT.

All of the distances D in these examples have the value 1. This follows from equation 3 in which SP(I)−EP(I) is zero because all proficiencies are assumed to be one. In fact, all the scores turn out to be the value of LogicRatio×WeightRatio in equation 7, because D equals 1 and NR also equals 1.

First, the individual skill weights are calculated:

Task 1: Since all skills are AND'ed together, the weights are easily calculated as

W(A)=1/16, W(B)=1/16, W(C)=1/16, W(D)=1/16, W(E)=1/16

SmallestWeight(SW)=W(A)+W(B)+W(C)+W(D)+W(E)=5/16

Task 2: Since all skills are OR'ed, the weights are easily calculated as

W(A)=16/16, W(B)=16/16, W(C)=16/16, W(D)=16/16, W(E)=16/16

SmallestWeight(SW)=W(A)=16/16=1

Task 3 and Task 4 are more difficult and require truth tables to figure out the weights.

TABLE 1
Truth Table for task 3

| A | B | C | D | E | OVERALL |
|---|---|---|---|---|---|
| | | | | T | |
| | | | T | | |
| | | | T | T | |
| | | T | | | |
| | | T | | T | |
| | | T | T | | |
| | | T | T | T | T |
| | T | | | | |
| | T | | | T | |
| | T | | T | | |
| | T | | T | T | |
| | T | T | | | |
| | T | T | | T | |
| | T | T | T | | |
| | T | T | T | T | T |
| T | | | | | |
| T | | | | T | |
| T | | | T | | |
| T | | | T | T | |
| T | | T | | | |
| T | | T | | T | |
| T | | T | T | | |
| T | | T | T | T | T |
| T | T | | | | T (SW = 18/16) |
| T | T | | | T | T |
| T | T | | T | | T |
| T | T | | T | T | T |
| T | T | T | | | T |
| T | T | T | | T | T |
| T | T | T | T | | T |
| T | T | T | T | T | T |
| 9 | 9 | 7 | 7 | 7 | |

Task 3: W(A) = 9/16, W(B) = 9/16, W(C) = 7/16 W(D) = 7/16 W(E) = 7/16
SmallestWeight(SW) = W(A) + W(B) = 9/16 + 9/16 = 18/16
Task 3 = (A & B)|(C & D & E)

Task 4

By drawing the truth table for task 4, it can also be shown that the weights for that skill expression are:

Task 4: W(A)=13/16, W(B)=7/16, W(C)=11/16, W(D)=6/16, W(E)=10/16

SmallestWeight(SW)=W(C)=11/16

Now that we have the weights for all the tasks, the scores for each task can be computed as follows:

For Task 1:

W(A)=1/16, W(B)=1/16, W(C)=1/16 W(D)=1/16 W(E)=1/16

TotalWeight=(W(A)+W(B)+W(C)+W(D)+W(E))=5/16

MatchedWeight=W(A)+W(B)+W(C)+W(D)+W(E))=5/16

$$LogicalRatio = 1 - ( \frac{\frac{( TW - SW )}{NZ}}{2} ) = 1 - ( \frac{\frac{( \frac{5}{16} - \frac{5}{16} )}{5}}{2} ) = 1$$

$$WeightRatio = 1 - ( \frac{MW - SW}{TW} ) = 1 - ( \frac{\frac{5}{16} - \frac{5}{16}}{\frac{5}{16}} ) = 1$$

Score=(Distance) (LogicRatio) (WeightRatio)(NR)=(1)(1)(1)(1)=1

For Task 2:

W(A)=16/16, W(B)=16/16, W(C)=16/16, W(D)=16/16, W(E)=16/16

TotalWeight=(1+1+1+1+1)=5

MatchedWeight=(1+1+1+1+1)=5

SmallestWeight=1

$$\begin{matrix}LogicalRatio = 1 - ( \frac{\frac{( TW - SW )}{NZ}}{2} ) = 1 - ( \frac{\frac{( 5 - 1 )}{5}}{2} ) \\ = 1 - ( \frac{\frac{( 4 )}{5}}{2} ) = 1 - ( \frac{4}{10} ) = 0.6 \\ Weight Ratio = 1 - ( \frac{MW - SW}{TW} ) = 1 - ( \frac{5 - 1}{5} ) = 0.2\end{matrix}$$

Score=(Distance) (LogicRatio) (WeightRatio)(NR)=(0.6)(0.2)=0.12

For Task 3:

W(A)=9/16, W(B)=9/16, W(C)=7/16, W(D)=7/16, W(E)=7/16

TotalWeight (9/16+9/16+7/16+7/16+7/16) (39/16)=2.4375

MatchedWeight=(9/16+9/16+7/16+7/16+7/16)=(39/16)=2.4375

SmallestWeight=18/16(from truth table)

$$\begin{matrix}LogicalRatio = 1 - ( \frac{\frac{( TW - SW )}{NZ}}{2} ) = 1 - ( \frac{\frac{( \frac{39}{16} - \frac{18}{16} )}{5}}{2} ) \\ = 1 - ( \frac{\frac{( \frac{21}{16} )}{5}}{2} ) = 0.86875 \\ WeightRatio = 1 - ( \frac{MW - SW}{TW} ) = 1 - ( \frac{\frac{39}{16} - \frac{18}{16}}{\frac{39}{16}} ) = 0.53846\end{matrix}$$

Score=(Distance) (LogicRatio) (WeightRatio)(NR)=0.46779

For Task 4:

W(A)=13/16, W(B)=7/16, W(C)=11/16, W(D)=6/16, W(E)=10/16

TotalWeight=(13/16+7/16+11/16+6/16+10/16)=(47/16)=2.9375

MatchedWeight=(13/16+7/16+11/16+6/16+10/16)=(47/16)=2.9375

SmallestWeight=11/16(from truth table)

$$\begin{matrix}LogicalRatio = 1 - ( \frac{\frac{( TW - SW )}{NZ}}{2} ) = 1 - ( \frac{\frac{( \frac{47}{16} - \frac{11}{16} )}{5}}{2} ) \\ = 1 - ( \frac{\frac{( \frac{36}{16} )}{5}}{2} ) = 1 - ( \frac{\frac{( 42 )}{5}}{2} ) = 0.775 \\ WeightRatio = 1 - ( \frac{MW - SW}{TW} ) = 1 - ( \frac{\frac{47}{16} - \frac{11}{16}}{\frac{47}{16}} ) = 0.2340\end{matrix}$$

Score=(Distance) (LogicRatio) (WeightRatio)(NR)=0.18138

The above tasks 1 through 4 assumes that there is one agent with a proficiency level of 1 in all skills A through E, and that the required proficiency levels in all skill expressions is also 1. Therefore, the calculation of the scores for the tasks determines in this example of one agent the order that the tasks 1 through 4 should be dispatched to the agent. Recall that a score of 1 is a perfect match and that less perfect matches decrease toward 0. Therefore, the calculated order of dispatching these interactions to the agent according to the computation of weights for the different skill expressions is:

Interaction 1 (A & B & C & D & E)=score of 1

Interaction 3 (A & B )|(C & D & E score of 0.46779

Interaction 4 (A & !B)|(C & !D)|(A & E) score of 0.18138

Interaction2 (A|B|C|D|E)=score of0.12

Because of the calculation of a weight for each skill according to the importance of the skill in the skill expression, the calculated score reflects the selection of an agent, or in the case of the above example, the dispatching of individual tasks, according to the best match of available skills to required skills.

The next example assumes that a task center has eight agents of varying skills and proficiencies. Table 2 shows an illustrative agent resume table of skills for this illustrative task center. The task center might receive telephone calls, e-mail, World-Wide-Web (WWW) based inquiries or other types of tasks, including tasks not yet defined. For this example, it is assumed that four skills A, B, C and D are defined for the servicing of tasks. The logical relationship of skills required to service any given task (the skill expression) might be obtained from a database accessed by a user identification, or obtained by prompting a caller with questions and collecting answers dialed from a telephone, or perhaps from a WWW form filled in by a user. For this example, it is assumed that the agents have the skills and associated proficiencies set forth in Table 2.

Table 2

TABLE 2

| SKILL | | | | |
|---|---|---|---|---|
| AGENT | A | B | C | D |
| A1 | 5 | | | |
| A2 | | 8 | | |
| A3 | | | 6 | |
| A4 | | | | 5 |
| A5 | 5 | 5 | | 6 |
| A6 | | 7 | 6 | 5 |
| A7 | 9 | 9 | 5 | |
| A8 | 7 | 7 | 8 | 9 |

Assume that a task arrives and it is determined by any desirable means that the skill expression required to service the task is A=5 & B=5 & (C=5 |D=5), where & refers to the logical AND operation and | refers to the logical OR operation. The task is to determine the agent best qualified to service the task. This will be the agent whose calculated score is closest to 1.

The weights for each skill are calculated from the skill expression according to the corresponding truth table in Table 3.

TABLE 3

| A | B | C | D | A & B & (C\|D) |
|---|---|---|---|---|
| | | | T | |
| | | T | | |
| | | T | T | |
| | T | | | |
| | T | | T | |
| | T | T | | |
| | T | T | T | |
| T | | | | |
| T | | | T | |
| T | | T | | |
| T | | T | T | |
| T | T | | | |
| T | T | | T | T (SW = 8/8) |
| T | T | T | | T |
| T | T | T | T | T |
| Y(A) = 3 | Y(B) = 3 | Y(C) = 2 | Y(D) = 2 | |

For this example,

m=the number of unique skills appearing in the logical expression=A,B,C,D=4

n=the number of unique skills appearing in the skill set=A,B,C,D=4

q=the number of skills in both the skill set and the expression=A,B,C,D=4.

Also, for this example 2^{(m}⁻¹⁾=2⁽⁴⁻¹⁾=8.

According to the invention, the calculated weight for each skill is y(I)/2m⁻¹=y(I)/8, or for each skill A-D, respectfully,

W(A)=⅜,

W(B)=⅜,

W(C)=2/8,

W(D)=2/8.

By comparing the skill expression to the agent resume table, it is immediately seen that agents A1, A2, A3, A4 and A6 don't qualify for the required skill expression. The algorithm next calculates a score for each of the remaining agents A5, A7 and A8.

In this example,

Proceeding through the calculations:

Agent A5

m=4; n=3; q=3; nz=3

TotalWeight=(W_{A}+W_{B}+W_{C}+W_{D})

TotalWeight=(⅜+⅜+2/8+2/8)=(10/8)=1.25

SmallestWeight=8/8=1

MatchedWeight=(⅜+⅜+2/8)=(8/8)=1

$$\begin{matrix}\begin{matrix}LogicalRatio = 1 - ( \frac{\frac{( TW - SW )}{NZ}}{2} ) = 1 - ( \frac{\frac{( \frac{10}{8} - \frac{8}{8} )}{4}}{2} ) = 0.96875 \\ WeightRatio = 1 - ( \frac{MW - SW}{TW} ) = 1 - ( \frac{\frac{8}{8} - \frac{8}{8}}{\frac{10}{8}} ) = 1\end{matrix} \\ \begin{matrix}D = ( 1 - {\sum }_{i = 1 …q} \frac{{w}_{i} \times ( {SP}_{i} - {EP}_{i} )}{10 \times q} ) \\ = ( 1 - {\sum }_{i = 1 …3} \frac{{w}_{i} \times ( {SP}_{i} - {EP}_{i} )}{10 \times 3} ) \\ = ( 1 - [ ( \frac{3}{8} ) ( 0 ) + ( \frac{3}{8} ) ( 0 ) + ( \frac{2}{8} ) ( 6 - 5 ) ] / 30 ) \\ = 1 - [ \frac{2}{8} ] / 30 = 0.99167\end{matrix}\end{matrix}$$

Score=(Distance) (LogicRatio) (WeightRatio) (NR)=0.99167×0.96875=0.96068

Agent A7

m=4; n=3; q=3; nz=3

TotalWeight=10/8=1.25 (from above)

SmallestWeight=8/8=1 (from above)

MatchedWeight=(⅜+⅜+2/8)=1

LogicRatio=0.96875 (from above)

Distance=1−[(⅜)(9−5)+(⅜)(9−5)+(2/8)(5−5)]/30=1−[1.5+1.5]/30=0.90

Score=(0.90)(0.96875)=0.871875

Agent A8

$$m = 4 ; n = 4 ; q = 4 ; nz = 4$$

$$TotalWeight = \frac{10}{8} = 1.25 ( from above )$$

$$SmallestWeight = \frac{8}{8} = 1 ( from above )$$

$$MatchedWeight = ( \frac{3}{8} + \frac{3}{8} + \frac{2}{8} + \frac{2}{8} ) = ( \frac{10}{8} ) = 1.25$$

$$LogicRatio = 0.96875 ( from above )$$

$$Distance = 1 - [ ( \frac{3}{8} ) ( 7 - 5 ) + ( \frac{3}{8} ) ( 7 - 5 ) + \\ ( \frac{2}{8} ) ( 8 - 5 ) + ( \frac{2}{8} ) ( 9 - 5 ) ] / 40 \\ = 1 - [ \frac{26}{8} ] / 40 = 0.91875$$

$$Score = ( 0.91875 ) ( 0.96875 ) - 0.89004$$

According to the algorithm, agent A5 has the score closest to 1 and would be selected for the task. This can be verified in this simple example by comparing the required skill proficiencies to those in Table 2. It is clear that agent A5 is minimally qualified, followed by A7 and then A8, who is the most qualified.

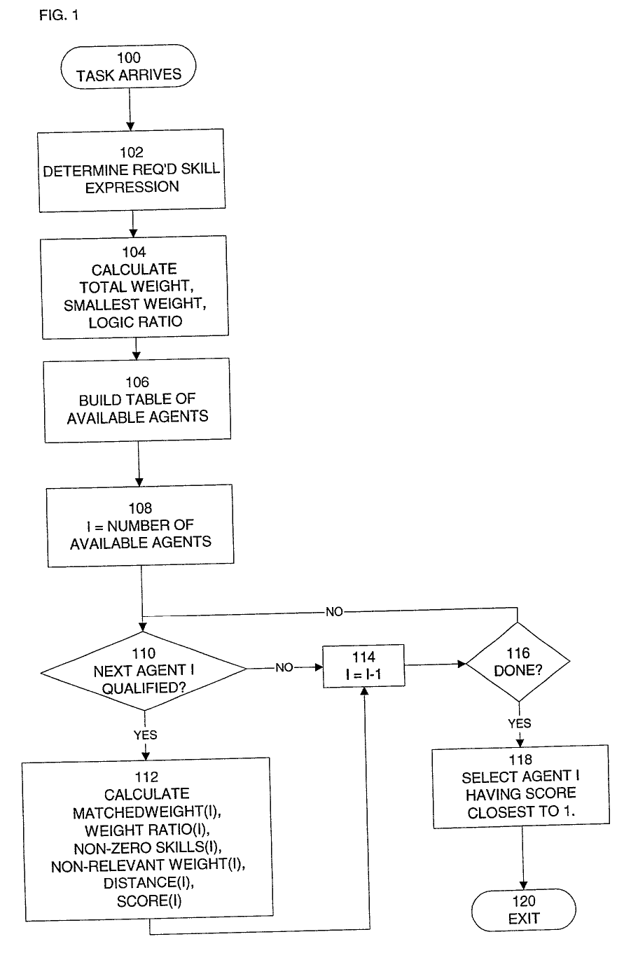

The flowchart of steps for the above examples is shown in FIG. 1. At entry point 100, it is assumed that a task arrives for servicing. Step 102 determines in any number of suitable ways the skills expression required to service the task. Step 104 calculates the variables TotalWeight, SmallestWeight and LogicRatio according to the equations discussed above. These variables depend only on the skill weights, which are calculated from the skill expression and the number of skills defined for the system and will be the same for all remaining iterations. Next, step 106 determines the available agents to be evaluated for servicing this task. Step 108 initiates a loop to evaluate each available agent. At step 110, the skill and proficiencies of the present agent is compared to the skill expression to determine if the agent is qualified to service the task. If the agent is not qualified, the loop counter is decremented at step 114 to address the next agent in the list, and step 110 is repeated if the list is not exhausted.

Assuming that an agent is qualified at step 110, step 112 calculates the variables MatchedWeight (MW), Distance D, Weight Ratio (WR), Non-Relevant Skills (NR), Non-Zero Weight (NZ) and Score (S) for this agent according to the formulas discussed above and stores the final value Score in a list awaiting final selection. Then the loop is continued to complete the calculation of a score for each available and qualified agent. When this is completed, step 118 examines the score list and selects an agent to service this task that has a score closest to the value one (1). Obviously, a scoring scale other than 0 to 1 can be used. This depends on scaling factors built into the equations that are used in any specific implementation. This preferred embodiment happens to prefer the score scale of 0 to 1.

It is understood that the above described arrangements are merely illustrative of the application of principles of the invention and that other arrangements may be devised by workers skilled in the art without departing from the spirit and scope of the invention. For example, the concept of proficiency levels can be removed from the preferred embodiment by assuming that all proficiency levels are 1 (one). In this case, the equations 1) through 8) of the preferred embodiment reduce to:

$$1 ) TotalWeight ( TW ) = {\sum }_{i = 1 … m} {w}_{i} \\ 2 ) MatchedWeight ( MW ) = {\sum }_{i = 1 … q} {w}_{i} ,$$

where q is the number of skills in common in both the skill set and the skill expression (I represents the skills S(I) that are members of the skill set and the skill expression).

3) SmallestWeight(SW)=Smallest summation of skills weights such that the skills satisfy the skill expression.

4) Distance (D)=1.

$$5 ) LogicRatio ( LR ) = 1 - ( \frac{\frac{( TW - SW )}{NZ}}{2} ) where$$

NZ is the number of skills with a weight of greater than zero.

$$6 ) WeightRatio ( WR ) = 1 - ( \frac{MW - SW}{TW} ) \\ 7 ) Non \text{-} Relevant Skills ( NR ) = min ( 1 , \frac{{2}^{m}}{{2}^{n}} )$$

8) Score (S)=D×LR×WR×NR

What is claimed:

1. A method of assigning tasks to agents in a service center based on agent skills required to service individual tasks, comprising
in response to a task to be serviced, ascertaining all agent skills relevant to process the task out of a set of n defined skills,
establishing a skill expression that defines a logical relationship between all skills relevant to service the task,
calculating a skill weight W(I) for each relevant skill I that represents the relative importance of the skill in the skill expression,
deriving a score for each agent qualified to service the task based on the calculated skill weights, and
selecting an agent to service the task from the set of qualified agents according to the scores of each qualified agent.

2. The method of claim 1 wherein the step of calculating a weight wᵢ for a given skill i further comprises calculating the value
$$\frac{a}{{2}^{m - 1}} ,$$
where a equals the number of times in the truth table corresponding to the skill expression that both the skill i and the skill expression are logically true and m is the number of unique skills specified in the skill expression.

3. The method of claim 2 wherein the step of deriving a set of qualified agents further comprises
calculating a total weight variable TW equal to the summation of the individual calculated weights of the relevant skills,
calculating a distance variable D for each agent equal to
$$( 1 - {\sum }_{i = 1 … q} \frac{{w}_{i} \times ( {SP}_{i} - {EP}_{i} )}{10 \times q} ) where$$
where SPᵢ is the proficiency of the agent for skill i and EPi is the required proficiency of skill i,
calculating a matched weight variable MW for each agent equal to the summation of the calculated weights for each skill possessed by the agent,
calculating a smallest weight variable SW equal to the smallest summation of weights for a combination of skills that satisfies the skill expression,
calculating a logic ratio variable LR equal to
$$1 - ( \frac{\frac{( TW - SW )}{NZ}}{2} ) where$$
NZ is the number of skills with a weight of greater than zero, calculating a weight ratio variable WR equal to
$$1 - ( \frac{MW - SW}{TW} ) ,$$
calculating a non-relevant skills ratio NR equal to min(1,
$$\frac{{2}^{m}}{{2}^{n}}$$
) calculating a score S for each agent equal to D times LR times WR times NR, and
selecting an agent to service the task based on the value of S.

4. A method of assigning tasks to agents in a service center based on agent skills required to service individual tasks, comprising
in response to a task to be serviced, ascertaining all agent skills relevant for processing the task out of a set of n defined skills and a level of proficiency associated with each task,
establishing a skill expression that defines a logical relationship between the relevant skills and their respective proficiency levels sufficient to qualify an agent to service the task,
calculating a weight for each relevant skill that represents the relative importance of the skill in the skill expression,
deriving a set of agents qualified to service the task according to the skill expression,
calculating a score for each qualified agent using the calculated weights, wherein each score represents the closeness of the associated agent's qualifications to the skill expression, and
selecting an agent to service the task according to the calculated scores.
